(19) United States
(12) Patent Application Publication
(10) Pub. No.: US 2002/0185834 A1
(43) Pub. Date: Dec. 12, 2002

(54) Manually movable trolley

(76) Inventors: Dieter Stockle, Landensberg (DE); Markus Riesenegger, Ettenbeuren (DE)

Correspondence Address: William C. Rowland, BURNS, DOANE, SWECKER & MATHIS, L.L.P., P.O. Box 1404, Alexandria, VA, 22313-1404, US

(21) Appl. No.: 10/211,307

(22) Filed: Aug. 5, 2002

Related U.S. Application Data
(63) Continuation of application No. PCT/DE01/04087, filed on Oct. 26, 2001.

(30) Foreign Application Priority Data
May 15, 2001 (DE) 101 23 647.6

(51) Int. Cl. B62B 5/04; B62B 3/00

(52) U.S. Cl. 280/47.34; 280/79.11

(57) ABSTRACT

A manually movable trolley includes a wheel frame provided with casters, a pushing arrangement carried by at least one curved longitudinal member, and a linkage linking the pushing arrangement with at least one of the casters, the linkage, starting from the pushing arrangement, is guided inside the at least one longitudinal member to the at least one caster, and the linkage is articulated by a plurality of intermediate pieces, and the intermediate pieces are arranged in succession and connected to one another in an articulated manner.

### CROSS-REFERENCE TO RELATED APPLICATIONS

The present application is a continuation of PCT Patent Application No. PCT/DE01/04087, filed on Oct. 26, 2001, and claims the priority of German Patent Application No. 101 23 647.6, filed on May 15, 2001, the entire contents of which are hereby incorporated herein by reference.

### BACKGROUND OF THE INVENTION

1. Field of the Invention

The invention relates to a manually movable trolley comprising a wheel frame provided with casters, and a pushing arrangement carried by curved longitudinal members and functionally co-operating with at least one of the casters via a linkage.

2. Description of Related Art

German utility model G 86 19 971.4 describes a trolley having a linkage. An intermediate piece of the linkage has two bores intended to hold an upper and a lower rod of the linkage in an articulated manner. When the linkage is installed, the intermediate piece is arranged in a curved region of one of the two longitudinal members. In this way, the linkage necessary for braking a rear caster, for example, can be movably guided inside a curved longitudinal member of the trolley. The drawing of the aforementioned utility model shows a trolley of which the longitudinal members carrying the pushing arrangement are only slightly curved.

### OBJECTS AND SUMMARY

An object of the invention is to provide a trolley of the type in question that can accommodate linkage to be guided in the longitudinal members, even when the latter are sharply curved.

The object is achieved in that at least one further intermediate piece is provided and in that the intermediate pieces are arranged in succession and connected to one another in an articulated manner.

Through the use of at least one further intermediate piece, the linkage can advantageously also be accommodated in sharply curved longitudinal members. When more than two intermediate pieces are used, it is even possible to accommodate linkage in a region with two curves facing in opposite directions, this being possible in a simple manner above all if the intermediate pieces each have a disc-shaped supporting portion intended to rest against the inner wall of the longitudinal members. In this way, the intermediate pieces cannot become jammed in the longitudinal members. Instead, the intermediate pieces adapt to the different curves so that linkage accommodated in the longitudinal members is movable in both directions without any problems.

### BRIEF DESCRIPTION OF THE DRAWINGS

The invention will be further described with reference to embodiments. In the drawings:

FIG. 1 shows a side view of a trolley.

FIG. 2 shows an intermediate piece.

FIG. 3 shows two intermediate pieces connected to one another in an articulated manner.

FIGS. 4, 5(a), and 5(b) show other advantageously formed intermediate pieces.

### DETAILED DESCRIPTION OF THE PREFERRED EMBODIMENTS

FIG. 1 shows a preferred embodiment of the present invention. A manually movable trolley 1, the wheel frame 2 of which has four casters 3, is provided with a loading platform 4. Starting from the rear region 5 of the wheel frame 2, two longitudinal members 6 comprising tubes extend upwards on both sides and carry a pushing arrangement 8 which, in the example, has a handle 9 pivotable to a limited extent in a known manner. The pushing arrangement 8 thus constructed is connected to a linkage 10 slidable to a limited extent inside at least one of the longitudinal members 6. The longitudinal members 6 are curved in two places, the curves 6′ facing in opposite directions in the example. The linkage 10 has an upper rod 11 connected at its upper end 12 to the pushing arrangement 8. The upper rod 11 is connected at its lower end 13 in an articulated manner to a row of like intermediate pieces 17 arranged in succession and connected to one another in an articulated manner. A lower rod 14 is connected at its upper end 15 in an articulated manner to the last of the intermediate pieces 17. The lower rod 14 is guided out of the longitudinal member 6 and connected at its lower end 16 to one of the casters 3. The pushing arrangement 8 functionally co-operates with at least one of the casters 3 via the linkage 10. By pivoting the pushing arrangement 8, for example the handle 9, the linkage 10 is moved along its longitudinal extent so that the corresponding caster 3 can be, e.g., braked or locked. It can clearly be seen from the drawings that the intermediate pieces 17 are easily capable of negotiating the curves 6′ by sliding round them, the upper rod 11 being guided in a straight portion of the longitudinal member 6 in the example shown.

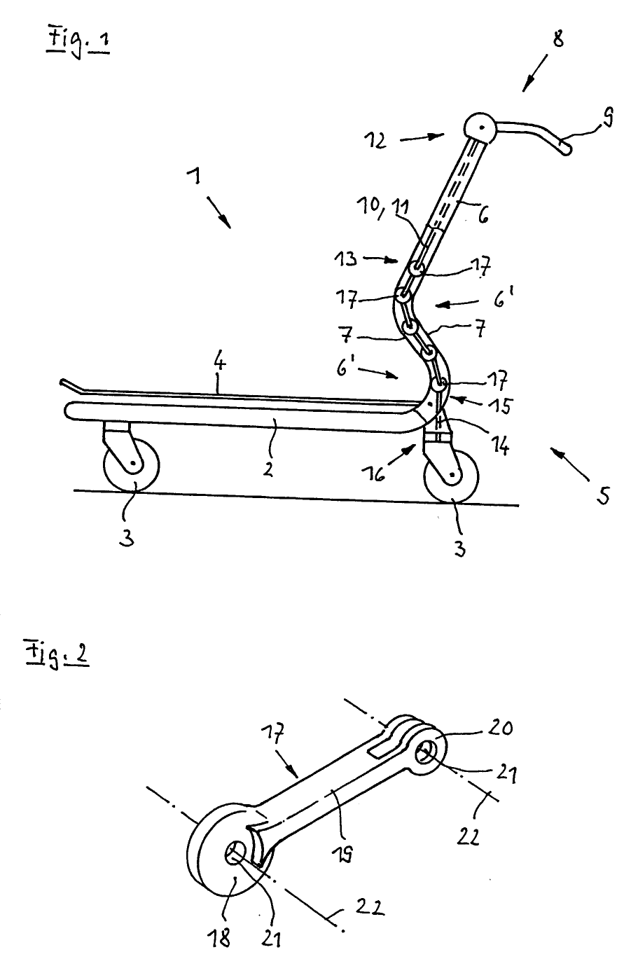

FIG. 2 shows a three-dimensional view of one of the intermediate pieces 17. Each intermediate piece 17 is formed as an elongate structure with a circular supporting portion 18 intended to support the intermediate piece 17 against the inner wall 7 of the longitudinal member 6. The supporting portion 18 is adjoined by a crosspiece 19, the thickness or width of which is smaller than the diameter of the supporting portion 18. The end of the crosspiece 19 opposite the supporting portion 18 is formed in the manner of a fork, the limbs of the forked portion 20 being eye-shaped. Both the supporting portion 18 and the forked portion 20 have a cylindrical opening 21 for receiving a pivot pin 23 by means of which the openings 21 are arranged on parallel axes 22. See FIG. 3.

As shown in FIG. 3, the intermediate pieces 17 can be connected in an articulated manner by suitable pivot pins 23. The upper and the lower rods 11, 14 of the linkage 10 can also be articulated on the respective last intermediate pieces 17 of a series of intermediate pieces 17 by means of the pivot pins 23. The forked portion 20 of the intermediate piece 17 shown on the left of FIG. 3 partially covers the supporting portion 18 of the intermediate piece 17 shown on the right. The pivot pin 23 extends through the forked portion 20 and the supporting portion 18 and is secured against loosening in a suitable manner. Two double arrows are shown in the drawings and are intended to indicate the movability of two articulated intermediate pieces 17.

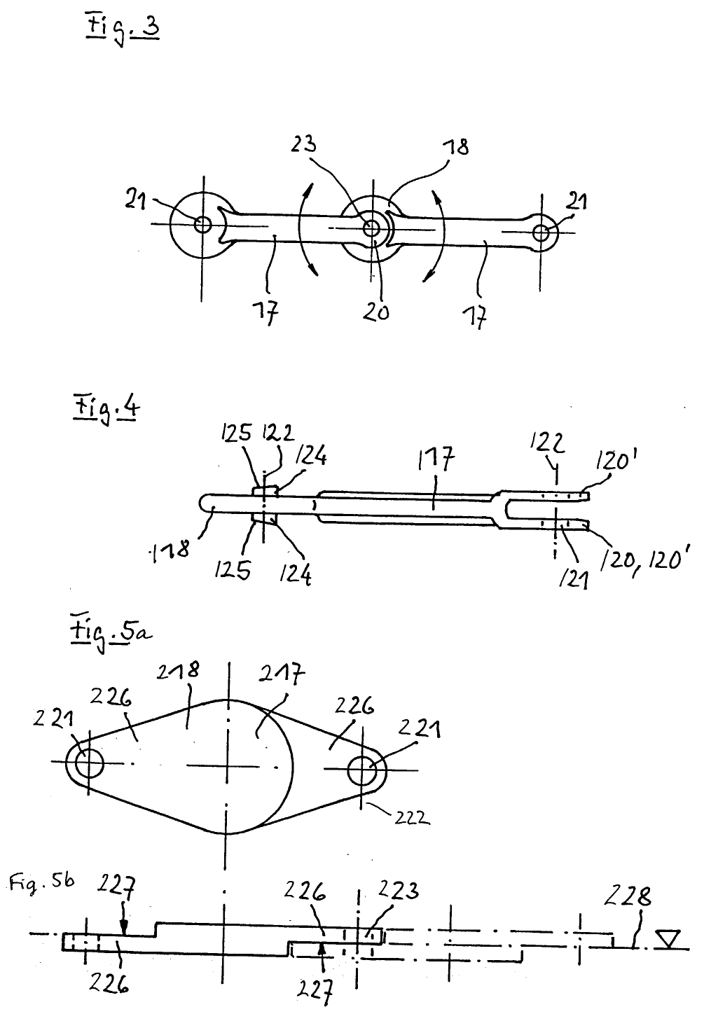

It is possible to omit the aforementioned separate pivot pins 23 if, as shown in FIG. 4, an outwardly extending, cylindrical pivot pin 124 arranged on the axis 122 is provided on the supporting portion 118 instead of a cylindrical opening 121. The pivot pins 124 are each provided with a chamfer 125 at the end, with the result that it is possible, in the case of plastics intermediate pieces 117, for the pivot pins 124 of a first intermediate piece 117 to engage in a snap-locking manner in the openings 121 in the forked portion 120 of a second intermediate piece 117. In this case, the supporting portion 118 of the first intermediate piece 117 is inserted between the limbs 120′ of the forked portion 120 of a second intermediate piece 117 until the two pivot pins 124 engage in the openings 121. Consequently, two or more intermediate pieces 117 can easily be arranged in succession and connected to one another in an articulated manner.

In the intermediate piece 217 shown in two views in FIGS. 5(a) and 5(b), the disc-shaped or circular supporting portion 218 is arranged centrally between two articulated arms 226. The articulated arms 226 each have a contact surface 227 arranged in a common plane 228 and extending into the plane 228 on one side from the left and on the other side from the right so that, owing to the resulting staggered arrangement of the articulated arms 226, two or more intermediate pieces 217 can be arranged in succession and connected to one another in an articulated manner; see dot-dash lines. The articulated connection can again be produced by separate pivot pins (as illustrated in FIG. 3) or by a moulded-on pivot pin (as illustrated in FIG. 4) which, arranged on one of the two articulated arms 226 along an axis 222, is intended to engage in a locked manner in a cylindrical opening 221 in a further intermediate piece 217; cf. also FIG. 4. In this case, with respect to the intermediate pieces 217, the pivot pin is provided on the first articulated arm 226 and the opening 221 is provided in the second articulated arm 226.

Although only preferred embodiments are specifically illustrated and described herein, it will be appreciated that many modifications and variations of the present invention are possible in light of the above teachings and within the purview of the appended claims without departing from the spirit and intended scope of the invention.

What is claimed is:

1. A manually movable trolley comprising:
a wheel frame provided with casters,
a pushing arrangement carried by at least one curved longitudinal member, and
a linkage linking the pushing arrangement with at least one of the casters,
the linkage, starting from the pushing arrangement, is guided inside the at least one longitudinal member to the at least one caster, and the linkage is articulated by a plurality of intermediate pieces, and the intermediate pieces are arranged in succession and connected to one another in an articulated manner.

2. The trolley according to claim 1, wherein each of the intermediate pieces has a supporting portion adapted to rest against an inner wall of the at least one longitudinal member and further has a forked portion adapted to connect the intermediate piece to the supporting portion of an adjacent one of the intermediate pieces in an articulated manner.

3. The trolley according to claim 2, wherein the supporting portion of each intermediate piece is circular.

4. The trolley according to claim 2, wherein the forked portion is intended to partially cover the supporting portion of the adjacent intermediate piece.

5. The trolley according to claim 3, wherein the forked portion is intended to partially cover the supporting portion of the adjacent intermediate piece.

6. The trolley according to claim 2, wherein the supporting portion and the forked portion of each intermediate piece are separated by a crosspiece.

7. The trolley according to claim 3, wherein the supporting portion and the forked portion of each intermediate piece are separated by a crosspiece.

8. The trolley according to claim 4, wherein the supporting portion and the forked portion of each intermediate piece are separated by a crosspiece.

9. The trolley according to claim 5, wherein the supporting portion and the forked portion of each intermediate piece are separated by a crosspiece.

10. The trolley according to claim 2, wherein the articulated connection between two intermediate pieces is produced by a pivot pin.

11. The trolley according to claim 3, wherein the articulated connection between two intermediate pieces is produced by a pivot pin.

12. The trolley according to claim 4, wherein the articulated connection between two intermediate pieces is produced by a pivot pin.

13. The trolley according to claim 6, wherein the articulated connection between two intermediate pieces is produced by a pivot pin.

14. The trolley according to claim 1, wherein each of the intermediate pieces has a supporting portion adapted to rest against an inner wall of the at least one longitudinal member, and further has at least one pivot pin arranged on each intermediate piece and is adapted for articulated insertion into an opening in a an adjacent one of the intermediate pieces.

15. The trolley according to claim 1, wherein the intermediate pieces are connected to one another in a locked manner.

16. The trolley according to claim 14, wherein the intermediate pieces are connected to one another in a locked manner.

17. The trolley according to claim 2, wherein the supporting portion is arranged centrally between two articulated arms.

18. The trolley according to claim 14, wherein the supporting portion is arranged centrally between two articulated arms.

19. The trolley according to claim 17, wherein each articulated arm has a contact surface arranged in a common plane, the contact surfaces extending into the q:common plane on one side from the left and on the other side from the right.

20. The trolley according to claim 18, wherein each articulated arm has a contact surface arranged in a common plane, the contact surfaces extending into the common plane on one side from the left and on the other side from the right.
